(19) United States
(12) Patent Application Publication
(10) Pub. No.: US 2026/0202151 A1
(43) Pub. Date: Jul. 16, 2026

(54) THREE-DIMENSIONAL HOLLOW HEAT EXCHANGER AND ITS APPLICATIONS

(71) Applicant: ZHEJIANG NORMAL UNIVERSITY, Jinhua, Zhejiang (CN)

(72) Inventors: Kaijian WANG, Jinhua, Zhejiang (CN); Pengwei CHENG, Jinhua, Zhejiang (CN)

(21) Appl. No.: 19/134,656

(22) PCT Filed: Feb. 1, 2024
(86) PCT No.: PCT/CN2024/075289

§ 371 Date: May 30, 2025

(30) Foreign Application Priority Data
Dec. 2, 2022 (CN) 202211540482.0
Dec. 2, 2022 (CN) 202211540536.3
Dec. 2, 2022 (CN) 202211540547.1

(51) Int. Cl. F28F 19/00; F28D 9/00

(52) U.S. Cl. CPC F28F 19/006; F28D 9/0037; F28D 9/0093

(57) ABSTRACT

A three-dimensional hollow heat exchanger and its applications. The three-dimensional hollow heat exchanger is formed by stacking and atomic diffusion bonding of multiple microstructure channel plates, comprising working fluid channel groups between adjacent microstructure channel plates. The microstructure channel plate includes a heat exchange zone and atomic diffusion bonding zones on both sides of the heat exchange zone along the O-X direction. The heat exchange zone is provided with multiple microstructures, and the microstructures have multiple cavities for adsorbing small impurity particles in liquid. The present application disperses small impurity particles in working fluid through numerous working fluid channel groups and provides multiple cavities on the microstructures, so that small impurity particles in the working fluid are induced to enter and be adsorbed in the cavities, thereby reducing small impurity particles in the working fluid and lowering the risk of freezing caused by small impurity particles acting as ice nuclei.

### FIELD OF THE INVENTION

The present application relates to the field of refrigeration technology, specifically to a three-dimensional hollow heat exchanger and its applications.

### BACKGROUND OF THE INVENTION

In the continuous generation of ultra-low temperature supercooled water, many problems are frequently encountered. For example: ice blockage can easily occur, the temperature of supercooled water fails to reach the target supercooling degree, and the continuous preparation time of supercooled water fails to reach the target time.

The heat exchanger is the core component of the entire supercooled water preparation system. How to optimize its performance to improve the continuous generation of ultra-low temperature supercooled water remains a century-old challenge.

In view of this, it is necessary to provide an improved heat exchanger and its applications to solve the above technical problems.

### BRIEF DESCRIPTION OF THE INVENTION

The object of the present application is to provide a three-dimensional hollow heat exchanger and heat exchanger assemblies and a supercooled water preparation system incorporating the same.

To solve one of the above technical problems, the present application adopts the following technical solutions.

A three-dimensional hollow heat exchanger, comprising multiple microstructure channel plates in a stacked arrangement and working fluid channel groups between adjacent microstructure channel plates, wherein the microstructure channel plate comprises a heat exchange zone and atomic diffusion bonding zones on both sides of the heat exchange zone along an O-X direction, the heat exchange zone is provided with multiple microstructures, and the microstructures have multiple cavities for adsorbing small impurity particles in liquid.

An inlet fluid stabilizing heat exchanger assembly, comprising: the above three-dimensional hollow heat exchanger, wherein the working fluid channels comprise alternately arranged multiple refrigerant channels and multiple water flow channels, a water inlet communicating with the water flow channels is located at and opens upward from a top of the compact heat exchanger, and a water outlet communicating with the water flow channels is located at and opens downward from a bottom of the compact heat exchanger; an inlet component, comprising a first connection structure connected to the water inlet and a second connection structure connected to an external water source, wherein the first connection structure has an upward-opening first insertion portion, the second connection structure has a downward-opening second insertion portion, and the second insertion portion is inserted into the first insertion portion, or a bottom end of the second insertion portion is flush with a top end of the second insertion portion, or the first insertion portion is inserted into the second insertion portion.

A heat exchanger assembly with supercooling elimination component, comprising: the above three-dimensional hollow heat exchanger, wherein the working fluid channels comprise alternately arranged multiple refrigerant channels and multiple water flow channels, a water inlet and a water outlet communicating with the water flow channels are located at a top and a bottom of the compact heat exchanger respectively; an outlet component connected to the water outlet, wherein the outlet component comprises a spiral pipe.

A supercooled water preparation system, comprising a refrigerant flow system, a water flow system, and a control system, wherein the refrigerant flow system comprises a refrigerant temperature control device, any one of the above heat exchangers, circulation pipelines connecting the refrigerant temperature control device with the refrigerant channels, and a circulation pump arranged on the circulation pipelines; the water flow system comprises a water flow temperature control device connected to a water source and controlling water temperature, the heat exchanger, water pipes connecting the water flow temperature control device with the water flow channels, and a water pump arranged on the water pipes; the control system is communicatively connected to the refrigerant temperature control device, the circulation pump, the water flow temperature control device, and the water pump.

The advantageous effects of the present application are: The present application disperses small impurity particles in working fluid through multiple working fluid channel groups, and provides multiple cavities on the microstructures that form the working fluid channel groups, so that small impurity particles in the working fluid are induced to enter and be adsorbed in the cavities, thereby reducing small impurity particles in the working fluid and lowering the risk of freezing caused by small impurity particles acting as ice nuclei in the working fluid.

### BRIEF DESCRIPTION OF THE DRAWINGS

The following detailed description of some specific embodiments of the present application will be made with reference to the accompanying drawings in an exemplary rather than limiting manner. The same reference numerals in the drawings indicate the same or similar components or parts. Those skilled in the art should understand that these drawings are not necessarily drawn to scale. In the drawings:

FIG. 1 is a structural diagram of a three-dimensional hollow heat exchanger according to a preferred embodiment of the present application.

FIG. 2 is an exploded view of FIG. 1.

FIG. 3 is a structural diagram of the heat exchanger body in FIG. 2.

FIG. 4 is an exploded view of FIG. 3.

FIG. 5 is a structural diagram of the microstructure channel plate in FIG. 4.

FIG. 6 (a) and (b) respectively show diagrams of microstructures in different embodiments.

FIG. 7 is a structural diagram showing the three-dimensional hollow heat exchanger of FIG. 1 placed in an insulation shell.

FIG. 8 is a sectional view along direction A-A′ of FIG. 7.

FIG. 9 is an assembly diagram showing FIG. 7 with inlet and outlet components.

FIG. 10 is a sectional view along direction B-B′ of FIG. 9.

FIG. 11 is an exploded view of the inlet component in FIG. 9.

FIG. 12 (a), (b), and (c) respectively show connection diagrams between the inlet component and the heat exchanger in different embodiments.

FIG. 13 is a connection diagram between the inlet component and the heat exchanger in another embodiment of the present application.

FIG. 14 is a sectional view along direction C-C′ of FIG. 13.

FIG. 15 is a structural diagram of the heat exchanger in FIG. 13.

FIG. 16 is a partial exploded view of FIG. 15.

FIG. 17 is an assembly diagram showing the heat exchanger with the outlet component in another embodiment of the present application.

FIG. 18 is a sectional view along direction D-D′ of FIG. 17.

FIG. 19 is a diagram of the supercooled water preparation system of the present application.

### DETAILED DESCRIPTION

The following detailed description of the present application will be made with reference to the specific embodiments shown in the drawings. However, these embodiments do not limit the present application, and any structural, methodological, or functional modifications made by those skilled in the art based on these embodiments are included within the scope of protection of the present application. In the various figures of the present application, for ease of illustration, certain dimensions of structures or parts may be exaggerated relative to other structures or parts, and therefore are only used to illustrate the basic structure of the subject matter of the present application.

Through years of research, the inventors have found that: supercooled water is in a metastable state, and during the preparation of supercooled water using a supercooled water preparation system, any minor change in any factor of the system may trigger ice blockage phenomena, which occur from time to time and happen randomly and uncontrollably. In fact, “ice blockage” is a description of a result, and the essence of the “ice blockage” problem is how to reduce the risk of impurities in water becoming ice nuclei.

As the core component of the supercooled water preparation system, the heat exchanger has effects on working fluid such as disturbance, uneven heat transfer, and thermal resistance control. These effects bring changes in heat transfer coefficients and have significant impacts on the occurrence of ice blockage. Ice blockage phenomena mostly occur at the heat exchanger, and the present application aims to design a three-dimensional hollow heat exchanger 1 to improve ice blockage phenomena occurring inside the heat exchanger during the supercooled water preparation process.

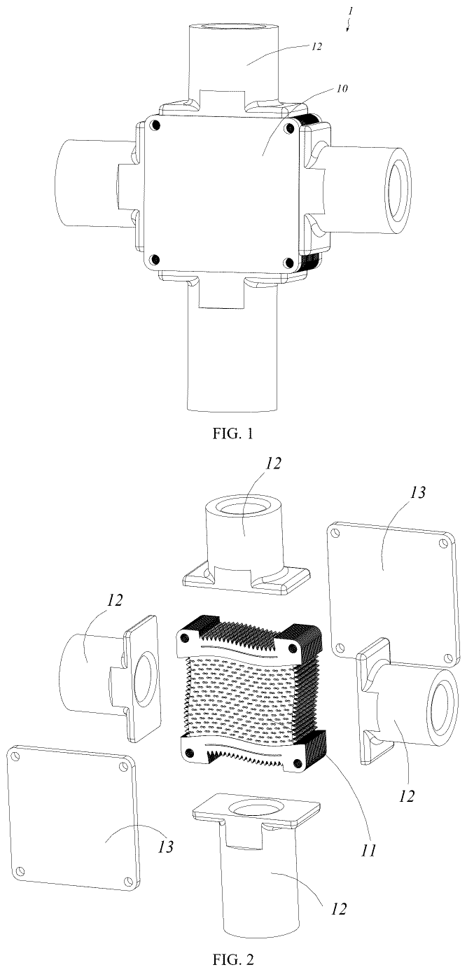

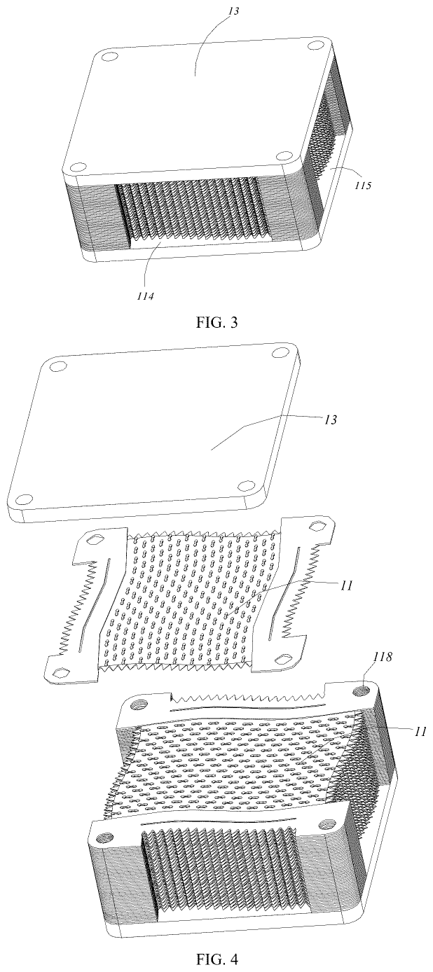

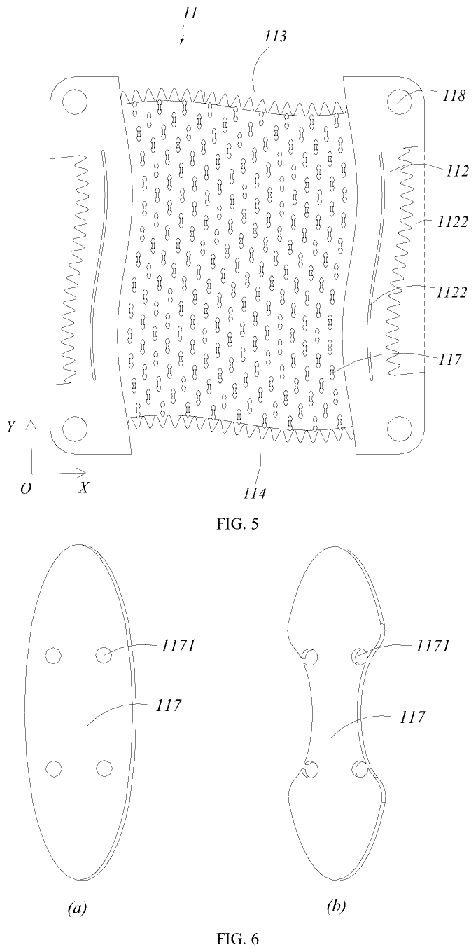

Referring to FIGS. 2-6, the three-dimensional hollow heat exchanger 1 of the present application includes a heat exchanger body 10 and pipe connection components 12 assembled on the heat exchanger body 10. The heat exchanger body 10 includes two end cover plates 13 and multiple microstructure channel plates 11 stacked and atomic diffusion bonded between the two end cover plates 13, working fluid channels are formed between adjacent microstructure channel plates 11, and the working fluid channels include alternately arranged multiple refrigerant channels and multiple water flow channels. The refrigerant flows in the refrigerant channels, water flows in the water flow channels, and heat exchange occurs when there is a temperature difference between them.

For ease of description, based on the microstructure channel plate 11 that forms the water flow channels, perpendicular O-X direction and O-Y direction are defined. The microstructure channel plate 11 includes a heat exchange zone 111 and atomic diffusion bonding zones 112 on both sides of the heat exchange zone 111 along the O-X direction. Along the O-Y direction, the ends of the atomic diffusion bonding zones 112 extend beyond the ends of the heat exchange zone 111 to form an inlet or outlet. The water flow channels have a water inlet 113 and a water outlet 114 at their ends, the refrigerant channels have a refrigerant inlet 115 and a refrigerant outlet 116 at their ends, and water flows along the O-Y direction between the two atomic diffusion bonding zones 112 through the heat exchange zone 111 to exchange heat with refrigerant in adjacent refrigerant channels.

The present application uses the same type of microstructure channel plate 11, rotated 90° and stacked in an offset arrangement, making the extension directions of refrigerant channels and water flow channels approximately perpendicular. In preferred scenarios, water flow channels generally extend along the height direction, while refrigerant channels generally extend horizontally.

The atomic diffusion bonding zone 112 has a recessed portion 1121 at an end away from the heat exchange zone 111 along the O-X direction. The degree of recession of the recessed portion 1121 is consistent with the length by which the atomic diffusion bonding zone 112 extends beyond the heat exchange zone 111 along the O-Y direction. This recessed portion 1121 forms a buffer chamber for working fluid inlet and outlet by penetrating through the stacking direction with the inlet or outlet at both ends of the heat exchange zone 111 along the O-Y direction.

Through further research, the inventors found that two conditions are required for impurities in water flow to form ice nuclei: 1) the water flow must have a certain degree of supercooling, and 2) small impurity particles in the water flow must reach a certain quantity at a specific time and location. Since supercooling degree is our target, the present application first optimizes the heat exchanger structure from the perspective of reducing the risk of small impurity particles causing freezing as ice nuclei.

The present application provides multiple microstructures 117 in the heat exchange zone 111. The microstructures 117 combine with adjacent microstructure channel plates 11 to divide the working fluid channel into multiple working fluid microchannels, also known as working fluid channel groups. First, multiple layers of working fluid channels are divided by multiple microstructure channel plates 11, then each layer of water flow channel is divided into multiple working fluid microchannel groups by the microstructures 117, making the number of small impurity particles in each microchannel very small, which can greatly reduce the probability of ice nucleus formation and further reduce the occurrence of ice blockage.

Preferably, the hydraulic equivalent diameter of the microchannel is not greater than 0.4 mm, the length of the microchannel is not greater than 50 mm, and the number of microchannels is not less than 600; when water flows through the microchannel at a flow rate of 0.0171/s~0.0321/s, the passage time through the three-dimensional hollow heat exchanger 1 is 0.038s~0.072s.

Furthermore, the present application provides multiple cavities 1171 on the microstructures 117 for adsorbing small impurity particles in liquid, so that small impurity particles in the working fluid are induced to enter and be adsorbed in the cavities 1171, reducing the distribution density/quantity of small impurity particles in the water flow within the fluid channels, thereby lowering the risk of small impurity particles causing freezing as ice nuclei. Here, the inventors explain the mechanism of small impurity particles entering the cavities 1171: Water flow carrying small impurity particles flows through the water flow channel groups and is induced to enter the cavities 1171 under pressure difference. Because small impurity particles carry positive charges and the heat exchanger material surface carries negative charges, small impurity particles are adsorbed on the surface of cavities 1171 through zeta-potential difference.

Explaining the mechanism of “water carrying small impurity particles being induced to enter cavities 1171”: According to Bernoulli principle, pressure difference exists where there is velocity difference; velocity is always a superposition of average components and fluctuating components. The space of cavities 1171 is wetted because the fluctuating components of velocity are constantly changing, and this change corresponds to uncertain disturbances, so fluid has the opportunity to enter any space surface that may contact the fluid.

Microchannels have a certain length, and working fluid continuously exchanges heat with another working fluid while flowing through working fluid microchannels. Therefore, the working fluid in the entire working fluid channel has a temperature gradient. Before reaching a certain degree of supercooling, the cavities 1171 on the microstructures 117 have adsorbed most of the small impurity particles, thus further reducing the risk of small impurity particles causing freezing as ice nuclei. Additionally, the three-dimensional hollow heat exchanger 1 has a service life. When the cavities 1171 on the microstructures 117 accumulate a certain amount of small impurity particles and cannot continue to induce and adsorb small impurity particles, especially in the latter half of the fluid flow direction, or when ice blockage occurs frequently in the three-dimensional hollow heat exchanger 1, the three-dimensional hollow heat exchanger 1 needs to be replaced.

In the present application, the cavities 1171 are formed by recessing inward from the surface of the microstructures 117. The depth of the cavities 1171 is between 0.1 mm and 0.2 mm, and/or the diameter of the cavities 1171 is between 0.025 mm and 0.075 mm, which can induce and adsorb sufficient small impurity particles while ensuring the supporting strength of the microstructures 117 and guaranteeing the service life of the product.

Additionally, the ratio of the sum of all cavities 1171 areas to the surface area of the microstructures 117 is between 1:10 and 1:100, which can also ensure a certain service life.

The top of the microstructures 117 in the protruding direction is used for bonding with adjacent microstructure channel plates 11, therefore the cavities 1171 are preferably arranged in any area except the top. Preferably, multiple cavities 1171 are arranged in central symmetry on the microstructures 117 relative to their centers. Alternatively, multiple cavities 1171 are randomly distributed on the microstructures 117.

In a specific embodiment, the microstructure 117 is elliptical, with one cavity 1171 in each of the four quadrants formed by its major and minor axes. Preferably, the four cavities 1171 are arranged in central symmetry, uniformly adsorbing small impurity particles from the microchannels on both sides.

Through further research, the inventors found that small velocity fluctuations of working fluid containing small impurity particles in working fluid channels easily cause freezing phenomena with small particles acting as ice nuclei. To reduce small velocity fluctuations of working fluid, the present application adopts one of the following optimization approaches.

On one hand, optimization through the shape of microstructures 117.

In the present application, the microstructure 117 is overall elliptical, with the length of the major semi-axis being 2 to 4 times that of the minor semi-axis. Therefore, the ends of microstructures 117 have a blunt shape, weakening the leading edge effect of microstructures 117 while maintaining low flow resistance, avoiding velocity fluctuations in passing working fluid, and preventing changes in heat transfer coefficient and flow separation caused by the end wall effects of microstructures 117.

Preferably, the length of the major semi-axis is 3 times that of the minor semi-axis. In one embodiment, the minor semi-axis is between 0.1 mm and 0.2 mm.

In another embodiment, based on the elliptical shape, the microstructure 117 is recessed inward at both ends along the minor axis direction, making it overall dumbbell-shaped; other designs remain unchanged.

On the other hand, optimization through controlling working fluid flow velocity in flow channels.

The width of the heat exchange zone 111 in the O-X direction remains consistent at any position along the O-Y direction, which can avoid sudden expansion or reduction of working fluid flow in fluid channel groups, thus preventing dramatic velocity changes and keeping heat transfer coefficient variations small.

Specifically, the side edge of the atomic diffusion bonding zone 112 facing the heat exchange zone 111 is a sinusoidal curve, and multiple microstructures 117 are arranged along sinusoidal curves extending in the O-Y direction, with the two sinusoidal curves being parallel. The sinusoidal curve function is y=a·sinx, where a is between 0.5 and 1, with relatively small amplitude; moreover, the length of the sinusoidal curve along the up-down direction is between 15 mm and 25 mm, including only one peak and trough arranged along the O-Y direction. This design creates certain disturbance to the working fluid, improving its heat exchange performance, while keeping the disturbance moderate to avoid excessive water flow fluctuations that might disrupt the metastable state of supercooled water and trigger freezing phenomena.

Alternatively, the side edge of the atomic diffusion bonding zone 112 facing the heat exchange zone 111 is a straight line extending along the O-Y direction, and multiple microstructures 117 are also arranged along straight lines extending in the O-Y direction.

Additionally, optimization through controlling working fluid velocity entering working fluid channel groups.

In the present application, at least one end of the microstructure channel plate 11 along the O-Y direction is serrated; preferably both ends are serrated, with the serrations uniformly distributing inlet velocity of working fluids such as refrigerant and water flow. During use, the end of the heat exchange zone 111 facing the inlet is serrated, or both ends of the heat exchange zone 111 facing the inlet and outlet are serrated.

Preferably, the edge of the recessed portion 1121 of the atomic diffusion bonding zone 112 away from the heat exchange zone 111 is also serrated, reducing working fluid resistance. Furthermore, the serrations have chamfers, serving to reduce resistance and guide flow. Through further research, the inventors found that external environmental temperature and its changes are also one of the causes producing micro-energy disturbances that promote ice nucleus formation leading to freezing.

On one hand, improvements to the heat exchanger body 10.

The present application provides vacuum grooves or air grooves 1122 on the atomic diffusion bonding zone 112, providing insulation effect from the peripheral side for working fluid in working fluid channel groups, avoiding the influence of external environmental temperature and its changes on working fluid temperature.

Preferably, the vacuum grooves or air grooves 1122 extend along the extension direction of the atomic diffusion bonding zone 112.

On the other hand, optimization of usage scenarios for the three-dimensional hollow heat exchanger 1.

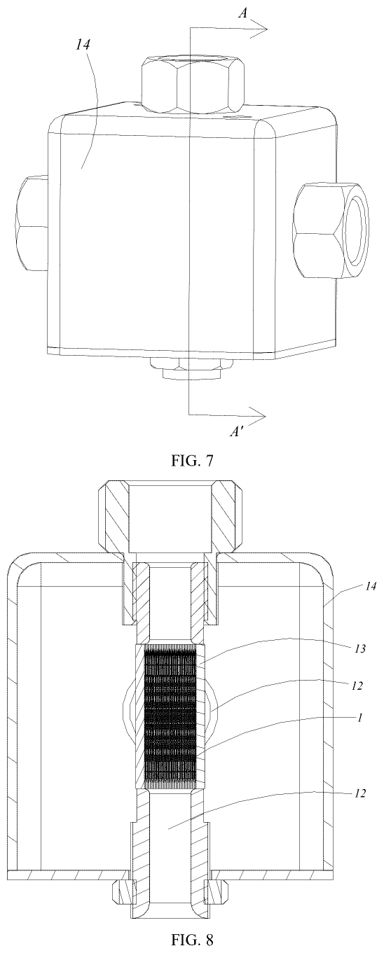

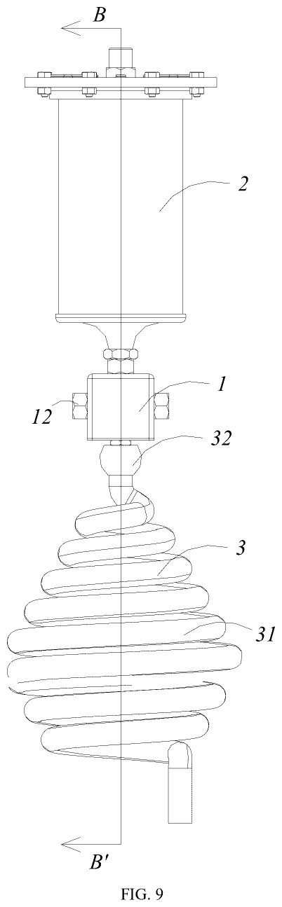

Referring to FIGS. 7 and 8, the present application places the three-dimensional hollow heat exchanger 1 in an insulation shell 14, with pipe connections on the exterior of the insulation shell 14. By adding insulation materials, such as polyurethane foam or vacuum insulation panels, in the interlayer between the insulation shell 14 and the three-dimensional hollow heat exchanger 1, the influence of environmental temperature on working fluid is reduced, ensuring stable internal heat exchange.

Based on the above configuration, the present application provides a method for preparing a three-dimensional hollow heat exchanger 1.

Step One: Prepare the heat exchanger body. First, based on the above design, form the microstructure channel plates 11 through photochemical etching or other processes, and create fixing holes 118 at the corners of the microstructure channel plates 11. Second, stack plates: fix positioning pins on one end cover plate 13, stack multiple microstructure channel plates 11 to a preset thickness with adjacent plates rotated 90 degrees, position the multiple microstructure channel plates 11 with pins through the fixing holes 118, and cap with another end cover plate 13. Finally, atomic diffusion bonding: use atomic diffusion bonding process to bond the above end cover plates 13 and microstructure channel plates 11 into an integral three-dimensional hollow heat exchanger body 10.

After stacking and atomic diffusion bonding, the water inlet 113 and water outlet 114 form water inlet and outlet chambers with the recessed portions 1121 of adjacent microstructure channel plates 11; the refrigerant inlet 115 and refrigerant outlet 116 form refrigerant inlet and outlet chambers with the recessed portions 1121 of adjacent microstructure channel plates 11. Step Two: Weld pipe connection components 12 at the water inlet and outlet chambers and refrigerant inlet and outlet chambers for quick connection with external piping. The pipe connection components 12 are optional accessories, determined by application scenarios. Here, besides facilitating assembly with other structures, the pipe connection components 12 also serve as extension sections of the water inlet 113 and water outlet 114.

After improving the three-dimensional hollow heat exchanger 1, we form a heat exchanger assembly by connecting an inlet component 2 at the water inlet 113 and an outlet component 3 at the water outlet 114, with the water inlet 113 located at and opening upward from the top of the three-dimensional hollow heat exchanger 1, and the water outlet 114 located at and opening downward from the bottom, optimizing the inlet component 2 and outlet component 3 to ensure stable water flow. When pipe connection components 12 are present, the inlet component 2 and outlet component 3 are indirectly connected to the water inlet 113 and water outlet 114 of the three-dimensional hollow heat exchanger 1 through the pipe connection components 12.

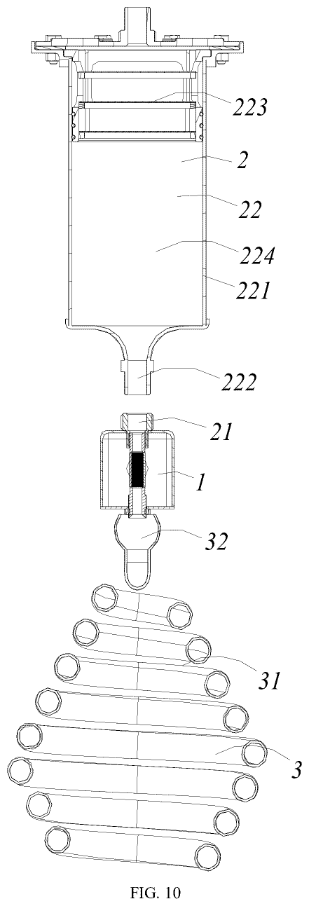

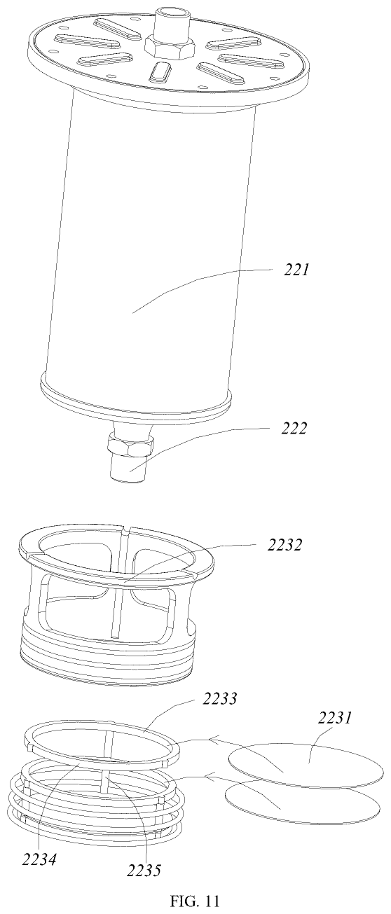

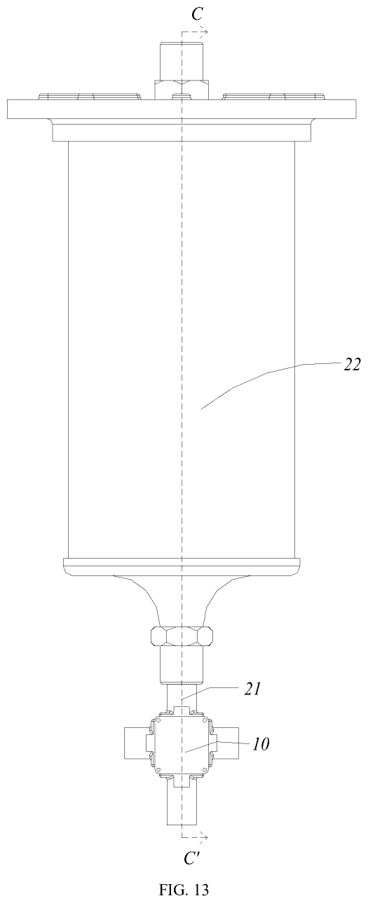

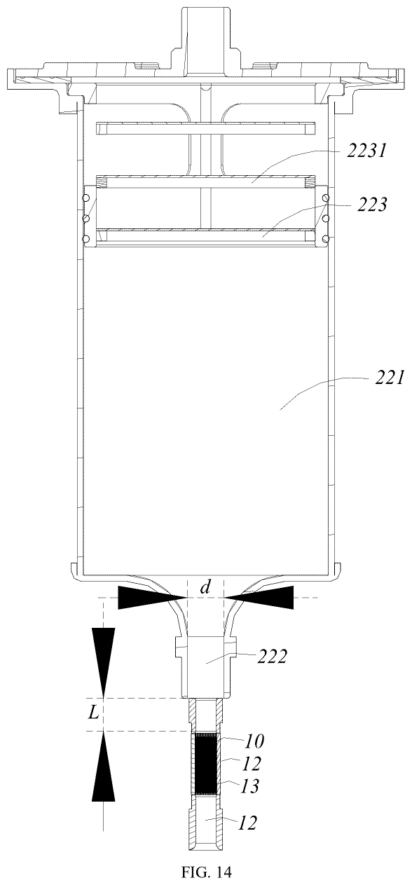

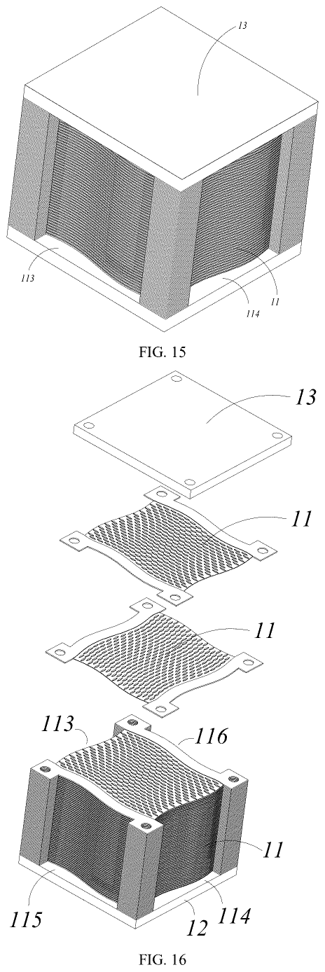

Referring to FIGS. 9-16, the inlet component 2 includes a first connection structure 21 connected to the water inlet 113 and a second connection structure 22 connected to external water source. They are connected so that water enters the three-dimensional hollow heat exchanger 1 under gravity and flows downward. In embodiments with pipe connection components 12, the pipe connection component 12 can serve as the first connection structure 21.

The first connection structure 21 is funnel-shaped, including a diameter-varying portion 211 connected to the three-dimensional hollow heat exchanger 1 and a first insertion portion 212 extending upward from the top of the diameter-varying portion 211. The first insertion portion 212 opens upward, and the inner diameter of the diameter-varying portion 211 gradually increases from top to bottom, allowing water to enter the three-dimensional hollow heat exchanger 1 smoothly.

The second connection structure 22 includes a water storage pool 221 and a second insertion portion 222 extending downward from the bottom of the water storage pool 221, with the second insertion portion 222 opening downward.

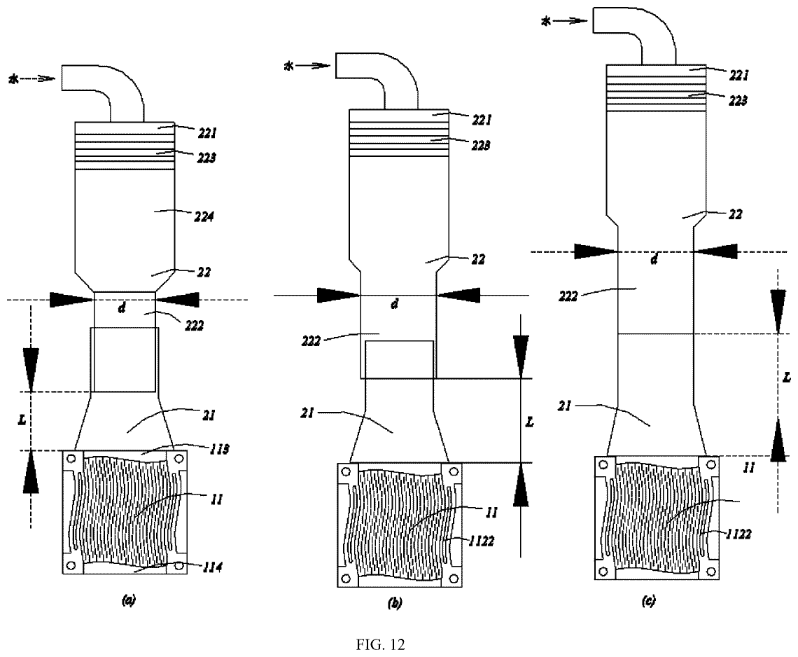

The second insertion portion 222 is inserted into the first insertion portion 212, or the first insertion portion 212 and second insertion portion 222 are aligned vertically, or the first insertion portion 212 is inserted into the second insertion portion 222, with the bottom end of the second insertion portion 222 flush with its top end, ensuring downward water flow after exiting the second insertion portion 222. The gap shown between the second insertion portion 222 and the first insertion portion 212 in FIG. 12 is for illustrating the insertion direction; no gap is needed in actual products.

Furthermore, the second connection structure 22 also includes a flow-regulating structure 223 located inside the water storage pool 221, which can adjust the flow pattern of water. The water inlet of the water storage pool 221 is located at its top, with the flow-regulating structure 223 in the upper portion and a certain calm space 224 left in the lower portion. When water flow velocity is high, fluctuations at the inlet of the water storage pool 221 are significant; the flow-regulating structure 223 is used to eliminate these fluctuations as much as possible; any remaining minor fluctuations gradually calm down in the calm space 224, resulting in very small fluctuations at the bottom outlet.

Preferably, in the height direction, the length of the flow-regulating structure 223 is less than that of the calm space 224; the larger the calm space 224, the calmer the water outflow. In one embodiment, the flow-regulating structure 223 is located in the top ⅓ portion of the height of the water storage pool, making the entire inlet component 2 well-balanced and preventing wobbling due to top-heaviness during use.

The flow-regulating structure 223 includes multiple layers of flow-regulating meshes 2231 arranged vertically, with through-holes on the flow-regulating meshes 2231 along the up-down direction. Water flow passing through the flow-regulating meshes 2231 is balanced and regulated, reducing working fluid velocity and velocity fluctuations, forming nearly ideal laminar flow working fluid that transfers into the three-dimensional hollow heat exchanger 1. Preferably, from top to bottom, the mesh number of the flow-regulating meshes 2231 gradually decreases. The topmost mesh has dense holes to eliminate water flow disturbances as much as possible at the top, with water flow becoming more stable closer to the heat exchanger, entering the three-dimensional hollow heat exchanger 1 smoothly. In a specific embodiment, the flow-regulating structure 223 includes three layers of flow-regulating meshes 2231, with mesh numbers of 60, 40, and 20 for the upper, middle, and lower layers respectively. To support the flow-regulating meshes 2231, the flow-regulating structure also includes a mesh frame 2232 and positioning structure 2233 within the mesh frame 2232. The positioning structure 2233 includes positioning rings 2234 for fixing the flow-regulating meshes 2231 and positioning posts 2235 for locating the positioning rings 2234, ensuring multiple flow-regulating meshes 2231 are coaxial with constant spacing.

Furthermore, referring to FIG. 12, where the diameter of the second insertion portion 222 is d, and the distance L between the bottom end of the second insertion portion 222 and the water inlet 113 satisfies L<6 d, ensuring laminar flow water inlet. One property of jet flow is the formation of a core region after passing through the outlet, whose range is related to the outlet diameter, L<6 d. L is the length of the core region, and d is the jet outlet diameter. The core region is laminar flow, and working fluid begins to diffuse outward beyond the core region. Specifically, d is between 10 mm and 20 mm.

Furthermore, to ensure the quality of water entering the heat exchanger, the second connection structure 22 contains water quality sensors to measure water resistance, i.e., checking impurity content in water flow. When water quality fails to meet standards, an alarm signal is issued to prevent ice blockage.

Preferably, considering the filtering effect of flow-regulating meshes 2231 on water flow, the water quality sensor is located downstream of the flow-regulating structure 223, providing measurements closer to the water quality entering the heat exchanger.

Additionally, inlet temperature sensors are installed in the second connection structure 22 to measure inlet water temperature without disturbing water flow, providing a basis for adjusting water and refrigerant temperatures.

Through further research, the inventors found that environmental temperature and its changes around the inlet component 2 affect inlet water temperature. Therefore, the inner and/or outer surfaces of the first connection structure 21 and second connection structure 22 have an insulation layer made of insulation materials, or the first connection structure 21 and second connection structure 22 are formed from insulation materials with thermal conductivity between 0.02 w/(m·K) and 0.045 w/(m·K), to avoid environmental temperature effects.

Alternatively, the inlet component 2 can be placed in the insulation shell together with the three-dimensional hollow heat exchanger 1 to avoid the influence of environmental temperature and its changes on water flow temperature.

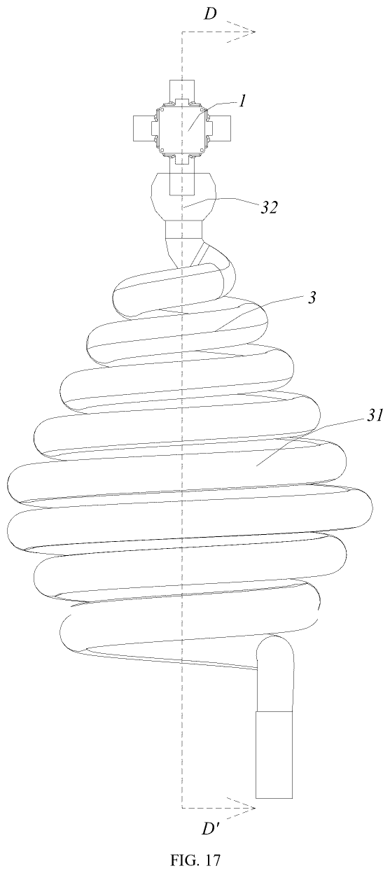

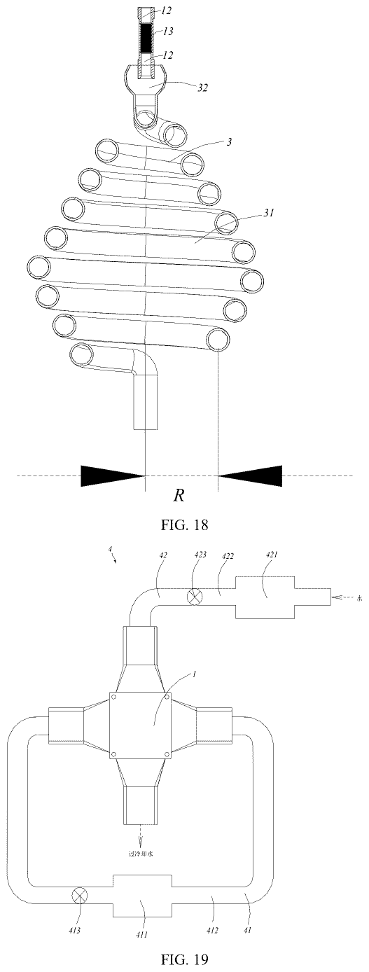

Referring to FIGS. 9-10 and 17-18, the outlet component 3 is connected to the water outlet 114, fully open downward, allowing supercooled water formed after heat exchange to flow directly into the outlet component 3, releasing supercooling before discharging externally, forming ice particles or ice slurry.

The outlet component 3 includes a spiral pipe 31. Supercooled water formed after heat exchange flows directly into the outlet component 3, gradually releasing supercooling through the centrifugal action of the spiral pipe 31, forming ice or ice slurry directly after flowing out at the outlet of the outlet component 3.

Specifically, the inner diameter of the spiral pipe 31 is between 15 mm and 25 mm, and its length along the water flow direction is between 200 mm and 400 mm, which can effectively release supercooling while preventing ice adhesion at the outlet.

To avoid excessive disturbance at the connection between the water outlet 114 of the heat exchanger or the outlet of the piping 12 and outlet component 3, the inflow direction of an end facing the water outlet 114 of the spiral pipe 31 aligns with the outflow direction of the water outlet 114 or an outlet of the piping 12, allowing water to flow smoothly into outlet component 3.

In a specific embodiment, multiple microstructures 117 are arranged along sinusoidal curves extending in the up-down direction, and the side edge of the atomic diffusion bonding zone 112 facing the heat exchange zone 111 is sinusoidal. Without piping 12 at the water outlet 114, water exiting the compact heat exchanger 1 flows at an angle rather than straight downward. The spiral pipe 31 has a greater degree of curvature than the atomic diffusion bonding zone 112, meaning the influence of the spiral pipe 31 on water flow angle is greater than that of the sinusoidal line, thus releasing supercooling in a short flow path and reducing ice blockage probability.

The spiral radius R of the spiral pipe 31 first increases or decreases, forming an overall spindle shape. Water flow first decelerates then accelerates, disturbing the supercooled state and releasing supercooling in the latter half, with the ninety-degree turn at the outlet causing supercooled water to impact or collide with the pipe wall at high velocity, further releasing supercooling.

Through further research, the inventors found that when supercooled water flows out of the compact heat exchanger 1, collision with any obstacle might produce ice under impact, affecting normal operation of the compact heat exchanger 1. Therefore, the outlet component 3 also includes an expanding diameter interface 32 connected to the inlet of spiral pipe 31. The inner diameter of the expanding diameter interface 32 is larger than the size of the water outlet 114 of the three-dimensional hollow heat exchanger, at least 1.5 times the water outlet 114. The expanding diameter interface 32 is not directly connected to the three-dimensional hollow heat exchanger 1, reducing water collision and splashing phenomena while facilitating installation, without requiring strict center alignment during assembly.

In a specific implementation, the expanding diameter interface 32 is spherical, preferably with smooth curved inner walls, with inner diameter first increasing then contracting to connect with spiral pipe 31, effectively preventing water splashing and enabling smooth water flow into spiral pipe 31.

Considering environmental temperature or its changes affecting water flow temperature in outlet component 3, the inner and/or outer surfaces of outlet component 3 have an insulation layer made of insulation materials, or outlet component 3 is formed from insulation materials; the thermal conductivity of the insulation materials is between 0.02 w/(m·K) and 0.045 w/(m·K), for example 0.034 w/(m·K). Alternatively, walls of the outlet component 3 contain air or vacuum interlayers. Or, outlet component 3 is placed in insulation shell 14 together with the three-dimensional hollow heat exchanger 1.

The insulation performance of inlet component 2 affects outlet water supercooling degree, while that of outlet component 3 affects supercooling release speed. Preferably, the insulation performance of outlet component 3 is better than the insulation performance of inlet component 2 to avoid temperature fluctuations causing ice blockage at outlet component 3.

Referring to FIGS. 1-19, the present application also provides a supercooled water preparation system 4, comprising a refrigerant flow system 41, water flow system 42, and control system (not shown).

The refrigerant flow system includes a refrigerant temperature control device 411, any of the above three-dimensional hollow heat exchangers 1, circulation pipelines 412 connecting the refrigerant temperature control device with refrigerant channels, and a circulation pump 413 on the circulation pipelines 412.

The water flow system 42 includes a water flow temperature control device 421 connected to water source and controlling water flow temperature, the three-dimensional hollow heat exchanger 1, water pipes 422 connecting the water flow temperature control device 421 with water flow channels, and a water pump 423 on the water pipes 422.

The control system is communicatively connected to the refrigerant temperature control device 411, circulation pump 412, water temperature control device 421, and water pump 422 to adjust working fluid flow velocity and temperature, thereby achieving target temperature supercooling degree.

The water flow temperature control device 411 is key to ensuring inlet water temperature, while the refrigerant temperature control device 421 is key to ensuring refrigerant inlet temperature. Both directly affect outlet water supercooling degree, thus requiring high temperature control performance.

Preferably, the three-dimensional hollow heat exchanger 1 is connected to the water flow system through the above inlet component 2 and outlet component 3.

The supercooled water preparation system of the present application can prepare supercooled water with higher supercooling degrees and significantly improved continuity. For example, when preparing −2.8° C. supercooled water, it can operate continuously for at least 1.8 hours; or when preparing −3.8° C. supercooled water, it can maintain operation for over 7 minutes, which represents a significant breakthrough in practical applications.

It should be understood that although this specification describes various embodiments, not every embodiment contains only one independent technical solution. This method of description in the specification is merely for clarity. Those skilled in the art should consider the specification as a whole, and the technical solutions in various embodiments can be appropriately combined to form other embodiments that those skilled in the art can understand. The series of detailed descriptions listed above are merely specific explanations of feasible embodiments of the present application and are not intended to limit the scope of protection of the present application. Any equivalent implementations or modifications that do not deviate from the technical spirit of the present application should be included within the scope of protection of the present application.

1. A three-dimensional hollow heat exchanger, comprising multiple microstructure channel plates in a stacked arrangement and working fluid channels between adjacent microstructure channel plates, wherein the microstructure channel plate comprises a heat exchange zone and atomic diffusion bonding zones on both sides of the heat exchange zone along an O-X direction, wherein the heat exchange zone is provided with multiple microstructures, and the microstructures have multiple cavities for adsorbing impurity particles in working fluid.

2. The three-dimensional hollow heat exchanger according to claim 1, wherein the cavities are formed by recessing inward from the surface of the microstructure, the depth of the cavities is between 0.1 mm and 0.2 mm, and/or the diameter of the cavities is between 0.025 mm and 0.075 mm.

3. The three-dimensional hollow heat exchanger according to claim 1, wherein a ratio of the area of all cavities to the surface area of the microstructure is between 1:10 and 1:100.

4. The three-dimensional hollow heat exchanger according to claim 1, wherein the multiple cavities are arranged on the microstructure in central symmetry relative to the center of the microstructure.

5. The three-dimensional hollow heat exchanger according to claim 1, wherein the microstructure is elliptical, and the length of the major semi-axis is 2 to 4 times the length of the minor semi-axis.

6. The three-dimensional hollow heat exchanger according to claim 1, wherein at least one end of the microstructure channel plate along the O-Y direction is serrated.

7. The three-dimensional hollow heat exchanger according to claim 6, wherein along the O-Y direction, an end of the atomic diffusion bonding zone extends beyond an end of the heat exchange zone to form an inlet or outlet, and the end of the heat exchange zone facing the inlet is serrated, or both ends of the heat exchange zone facing the inlet and outlet are serrated.

8. The three-dimensional hollow heat exchanger according to claim 7, wherein the atomic diffusion bonding zone has a recessed portion at an end away from the heat exchange zone along the O-X direction, an edge of the recessed portion away from the heat exchange zone is serrated, and the serration has chamfers.

9. The three-dimensional hollow heat exchanger according to claim 1, wherein the atomic diffusion bonding zone is provided with a vacuum groove or an air groove.

10. The three-dimensional hollow heat exchanger according to claim 1, wherein the width of the heat exchange zone in the O-X direction remains consistent at any position along the O-Y direction, wherein
the side edge of the atomic diffusion bonding zone facing the heat exchange zone is a sinusoidal curve, and the multiple microstructures are arranged along sinusoidal curves extending in the O-Y direction, with the two sinusoidal curves being parallel.

11. A heat exchanger assembly, comprising:
the three-dimensional hollow heat exchanger according to claim 1, wherein the working fluid channels comprise alternately arranged multiple refrigerant channels and multiple water flow channels, a water inlet communicating with the water flow channels is located at and opens upward from a top of the compact heat exchanger, and a water outlet communicating with the water flow channels is located at and opens downward from a bottom of the compact heat exchanger;
an inlet component, comprising a first connection structure connected to the water inlet and a second connection structure connected to an external water source, wherein the first connection structure has an upward-opening first insertion portion, the second connection structure has a downward-opening second insertion portion, and the second insertion portion is inserted into the first insertion portion, or a bottom end of the second insertion portion is flush with a top end of the second insertion portion, or the first insertion portion is inserted into the second insertion portion.

12. The heat exchanger assembly according to claim 11, wherein the diameter of the second insertion portion is d, a distance between the bottom end of the second insertion portion and the water inlet is L, and L<6 d.

13. The heat exchanger assembly according to claim 11, wherein the heat exchanger assembly further comprising:
an outlet component connected to the water outlet, wherein the outlet component comprises a spiral pipe.

14. The heat exchanger assembly according to claim 13, wherein the microstructure channel plate comprises a heat exchange zone and atomic diffusion bonding zones on both sides of the heat exchange zone in a horizontal direction, the heat exchange zone is provided with multiple microstructures arranged along sinusoidal curves extending in an up-down direction, and a side edge of the atomic diffusion bonding zone facing the heat exchange zone is a sinusoidal curve;
an inflow direction at an end of the spiral pipe facing the water outlet is consistent with an outflow direction of the water outlet, the spiral pipe has a greater degree of curvature than the atomic diffusion bonding zone, and a spiral radius of the spiral pipe first increases and then decreases.

15. A supercooled water preparation system, comprising a refrigerant flow system, a water flow system, and a control system, wherein:
the refrigerant flow system comprises a refrigerant temperature control device, the three-dimensional hollow heat exchanger according to claim 1, circulation pipelines connecting the refrigerant temperature control device with the refrigerant channels, and a circulation pump arranged on the circulation pipelines;
the water flow system comprises a water flow temperature control device connected to a water source and controlling water temperature, the heat exchanger, water pipes connecting the water flow temperature control device with the water flow channels, and a water pump arranged on the water pipes;
the control system is communicatively connected to the refrigerant temperature control device, the circulation pump, the water flow temperature control device, and the water pump.

16. The three-dimensional hollow heat exchanger according to claim 1, wherein the top of the microstructures in the protruding direction is used for bonding with adjacent microstructure channel plate, the cavities are preferably arranged in any area except the top.

17. The three-dimensional hollow heat exchanger according to claim 1, wherein the multiple cavities are randomly distributed on the microstructure.

18. The three-dimensional hollow heat exchanger according to claim 1, wherein the width of the heat exchange zone in the O-X direction remains consistent at any position along the O-Y direction, wherein
the side edge of the atomic diffusion bonding zone facing the heat exchange zone is a straight line along the O-Y direction, and the multiple microstructures are arranged along straight lines extending in the O-Y direction.

19. The three-dimensional hollow heat exchanger according to claim 1, wherein further comprising an insulation shell and pipe connections on the exterior of the insulation shell, the three-dimensional hollow heat exchanger is in the insulation shell, and insulation materials are in the interlayer between the insulation shell and the three-dimensional hollow heat exchanger.

20. The heat exchanger assembly according to claim 12, wherein d is between 10 mm and 20 mm.
